(19) United States
(12) Patent Application Publication
(10) Pub. No.: US 2024/0092187 A1
(43) Pub. Date: Mar. 21, 2024

(54) DC-DC CONVERTER, A VEHICLE INCLUDING THE CONVERTER, AND A CONTROLLING METHOD THEREOF

(71) Applicants: HYUNDAI MOTOR COMPANY, Seoul (KR); KIA CORPORATION, Seoul (KR)

(72) Inventors: Kyu Won Jeong, Hwaseong-si (KR); Mun Soo Chung, Uiwang-si (KR); Jae Hun Jeong, Anyang-si (KR); Beom Sik Kim, Gwangmyeong-si (KR); Tae Woo Kim, Anyang-si (KR)

(73) Assignees: HYUNDAI MOTOR COMPANY, Seoul (KR); KIA CORPORATION, Seoul (KR)

(21) Appl. No.: 18/219,780

(22) Filed: Jul. 10, 2023

(30) Foreign Application Priority Data
Sep. 20, 2022 (KR) 10-2022-0118719

(51) Int. Cl. B60L 50/51; B60L 58/31; H02M 1/00; H02M 3/157; H02M 3/158

(52) U.S. Cl. CPC B60L 50/51; B60L 58/31; H02M 1/007; H02M 3/157; H02M 3/158; B60L 2210/10; B60L 2210/42

(57) ABSTRACT

A direct current to direct current (DC-DC) converter, a vehicle including the converter, and a controlling method thereof are proposed. The DC-DC converter is capable of efficiently detecting and responding to miscoupling of a connector. The DC-DC converter includes a first inlet corresponding to a first DC terminal, a transformation circuit connected to the first DC terminal and a second DC terminal while being located therebetween, and a converter controller, wherein when receiving a voltage command corresponding to the first DC terminal from an external controller, the converter controller is configured to determine whether or not a connector coupled to the first inlet is miscoupled thereto based on whether or not a voltage of the first DC terminal follows the voltage command.

### CROSS REFERENCE TO RELATED APPLICATION

The present application claims priority to Korean Patent Application No. 10-2022-0118719, filed on Sep. 20, 2022, the entire contents of which are incorporated herein for all purposes by reference.

### TECHNICAL FIELD

The present disclosure relates generally to a direct current to direct current (DC-DC) converter, a vehicle including the converter, and a controlling method thereof. More particularly, the present disclosure relates generally to a DC-DC converter, which is capable of efficiently detecting and responding to miscoupling of a connector, a vehicle including the converter, and a controlling method thereof.

### BACKGROUND

Recently, as interest in the environment increases, the development of an electrified vehicle having a motor as a driving source is being actively performed. As an example of the electrified vehicle, a fuel cell electric vehicle (FCEV) may be proposed.

The fuel cell vehicle may be referred to as a vehicle that travels by driving an electric motor with power generated through a chemical reaction between hydrogen and oxygen in a fuel cell. In order to stably supply power to the motor, a high voltage battery may be provided between a motor driving system including the electric motor and the inverter, and the fuel cell. In order to increase the efficiency and storage capacity, a voltage of the high-voltage battery may increase.

Accordingly, when a voltage of a high-voltage battery is significantly higher than a voltage of the fuel cell, a direct current to direct current (DC-DC) converter is disposed between the fuel cell and the high-voltage battery to allow power exchange between the fuel cell and the high voltage battery. Here, among opposite terminals of the DC-DC converter, a first terminal connected to the fuel cell with relatively low voltage is a low-voltage side (LS), and a second terminal connected to the high-voltage battery with relatively high voltage is a high-voltage side (HS).

The low-voltage side and the high-voltage side of the DC-DC converter respectively have inlets and a connector of a cable is generally connected thereto to exchange power with a device corresponding to each side. However, the connector and the inlet are coupled to each other while voltage specifications therebetween are not matched such as a connector to be coupled to the low-voltage side inlet is coupled to the high-voltage side, and the like, or when two or more DC-DC converters are mounted to a vehicle at the same time, a situation where a connector to be coupled a corresponding DC-DC converter is miscoupled may occur during vehicle production or maintenance. In the miscoupling situation, when the DC-DC converter is operated, failure may occur in the DC-DC converter or in other devices connected to the DC-DC converter.

The foregoing is intended merely to aid in the understanding of the background of the present disclosure. The foregoing is not intended to mean that the present disclosure falls within the purview of the related art that is already known to those having ordinary skill in the art.

### SUMMARY

The present disclosure provides a direct current to direct current (DC-DC) converter, a vehicle including the same, and a controlling method thereof, wherein when a connector is miscoupled to an inlet, the converter is capable of efficiently detect and respond to the miscoupling.

The technical problem of the present disclosure is not limited to the above mentioned. Other problems not mentioned should be clearly understood by those having ordinary skill in the art from the description below.

In one embodiment of the present disclosure, a DC-DC converter includes: a first inlet corresponding to a first DC terminal; a transformation circuit connected to the first DC terminal and a second DC terminal while being located therebetween; and a converter controller. In particular, when receiving a voltage command corresponding to the first DC terminal from an external controller, the converter controller may be configured to determine whether a connector coupled to the first inlet is miscoupled thereto based on whether or not a voltage of the first DC terminal follows the voltage command.

The external controller may include a fuel cell control unit (FCU) configured to control a fuel cell.

When the voltage of the first DC terminal follows the voltage command, the converter controller may determine that coupling of the connector may be normally performed.

When the voltage of the first DC terminal does not follow the voltage command, the converter controller may determine that miscoupling of the connector may occur.

When the voltage of the first DC terminal does not follow the voltage command, the converter controller may transmit an error signal.

When the voltage of the first DC terminal does not follow the voltage command, the converter controller may perform a shutdown operation.

The voltage command may be transmitted after informing the external controller of an operation state in which power converting starts.

The DC-DC converter may include: a second inlet corresponding to the second DC terminal.

The transformation circuit may include: an inductor of which a first terminal is connected to a positive (+) terminal of the first DC terminal; and a leg of which a first terminal may be connected to a positive (+) terminal of the second DC terminal and a second terminal may be connected to a negative (−) terminal of the second DC terminal, wherein the leg may include two switching elements connected to each other in series, and a second terminal of the inductor may be connected to a connection node of the two switching elements.

According to an embodiment of the present disclosure, a vehicle may include: a first power source; a first controller configured to control the first power source; and a DC-DC converter including a first inlet corresponding to a first DC terminal, wherein when receiving a voltage command corresponding to the first DC terminal from the first controller, the DC-DC converter may determine whether a connector coupled to the first inlet is miscoupled thereto based on whether or not a voltage of the first DC terminal follows the voltage command.

The first power source may include a fuel cell, and the first controller may include a fuel cell control unit (FCU) configured to control the fuel cell.

When the voltage of the first DC terminal follows the voltage command, the DC-DC converter may determine that coupling of the connector may be normally performed.

When the voltage of the first DC terminal does not follow the voltage command, the converter controller may determine that miscoupling of the connector may occur.

The vehicle may include: an output device configured to transmit visual or audible warning information, wherein when a voltage of the first DC terminal does not follow the voltage command, the DC-DC converter may transmit an error signal to the output device.

The vehicle may include: a second power source and a second controller configured to control the second power source, wherein the DC-DC converter may include a second inlet corresponding to a second DC terminal.

According to an embodiment of the present disclosure, a vehicle may include: a plurality of DC-DC converters; a plurality of fuel cells each corresponding to one DC terminal of different one DC-DC converter among the plurality of DC-DC converters; and a plurality of fuel cell controllers each configured to control different one fuel cell among the plurality of fuel cells, wherein when transmitting a voltage command corresponding to the one DC terminal from a corresponding fuel cell controller among the plurality of fuel cell controllers, each of the plurality of DC-DC converters may determine whether or not miscoupling of a connector coupled to an inlet corresponding to the one DC terminal occurs, based on whether or not a voltage of the one DC terminal follows the voltage command.

According to an embodiment, the DC-DC converter can efficiently detect and respond to connector miscoupling.

Specifically, the DC-DC converter determines whether or not miscoupling occurs based on whether or not the actual voltage follows the voltage command with respect to one side, and when the miscoupling is determined, operation is stopped, thereby protecting the DC-DC converter and the devices connected thereto.

The effect of the present disclosure is not limited to the above mentioned. Other effects not mentioned should be clearly understood by those having ordinary skill in the art from the description below.

### BRIEF DESCRIPTION OF THE DRAWINGS

In order that the disclosure may be well understood, there is now described various forms thereof, given by way of example, reference being made to the accompanying drawings, in which:

FIG. 1 is a view illustrating the configuration of a power electronic system of a fuel cell vehicle according to an embodiment of the present disclosure;

FIG. 2A is a view illustrating a control system of a fuel cell vehicle according to an embodiment of the present disclosure;

FIG. 2B is a view showing a modified embodiment of part ‘A’ in FIG. 2A;

FIG. 3 is a view illustrating an exchange signal within a fuel cell controller, a direct current to direct current (DC-DC) converter, and a cluster according to an embodiment of the present disclosure;

FIG. 4 is a perspective view illustrating the exterior shape of the DC-DC converter according to an embodiment; and

FIG. 5 is a flowchart illustrating a control process of a vehicle according to an embodiment of the present disclosure.

### DETAILED DESCRIPTION OF THE DISCLOSURE

Hereinbelow, embodiments described in the specification are described in detail with reference to accompanying drawings. Regardless of the reference numerals, the same reference numerals refer to the same or like parts, and redundant descriptions thereof are omitted. The suffixes “module” and “part” for the components used in the following description are given or mixed in consideration of only the ease of writing the specification, and do not have distinct meanings or roles by themselves. Furthermore, if it is decided that the detailed description of known function or configuration related to the disclosure makes the subject matter of the disclosure unclear, the detailed description is omitted. Furthermore, the accompanying drawings are only for understanding of embodiments of the present disclosure, and the technical ideas disclosed in the specification are not limited by the accompanying drawings. Those having ordinary skill in the art should appreciate that various modifications, additions, and substitutions are possible, without departing from the scope and spirit of the disclosure as disclosed in the accompanying claims.

It should be understood that, although the terms first and/or second, and the like may be used herein to describe various elements, these elements should not be limited by these terms. These terms are only used to distinguish one element, from another element.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween.

Singular forms are intended to include plural forms unless the context clearly indicates otherwise.

It should be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Furthermore, a unit or a control unit included in names such as a motor control unit (MCU), a hybrid control unit (HCU), and the like, is only a widely used term for a controller that controls a specific function of a vehicle and does not mean a generic function unit. For example, the controller may include a communication device communicating with other controllers or a sensor to control the function in charge, a memory storing an operation system or a logic command and input/output information, and at least one process performing determination, calculation, and decision necessary for controlling the function in charge.

When a component, device, element, or the like, of the present disclosure, is described as having a purpose or performing an operation, function, or the like, the component, device, or element should be considered herein as being “configured to” meet that purpose or to perform that operation or function.

The following embodiments are described on the assumption that embodiments are applied to a hydrogen fuel cell vehicle, but the description is for convenience of explanation. It should be clear to those having ordinary skill in the art that the embodiments can be applied to a vehicle equipped with two batteries having different normal voltage ranges in addition to the hydrogen fuel cell vehicle.

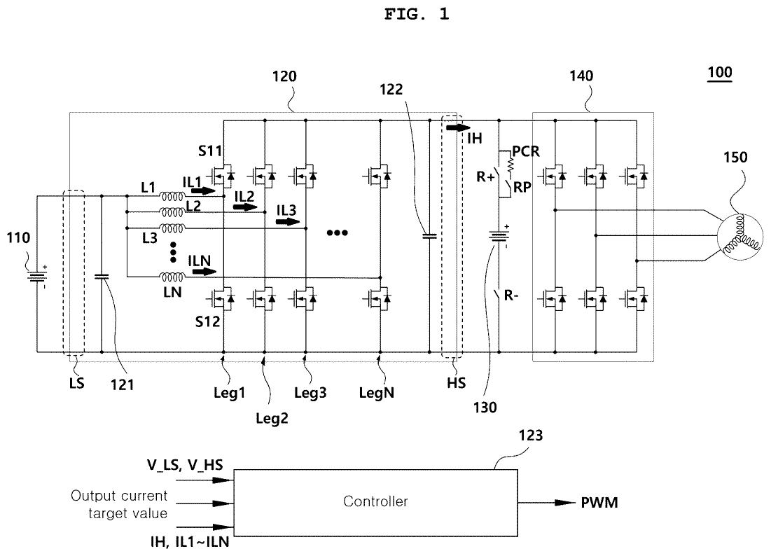

FIG. 1 is a view showing the configuration of a power electronic system of a fuel cell vehicle according to an embodiment of the present disclosure.

Referring to FIG. 1, according to an embodiment, a fuel cell vehicle 100 may include a fuel cell 110, a direct current to direct current (DC-DC) converter (FDC: Fuel cell DC-DC Converter) 120 of which a first end is connected to the fuel cell 110, a high voltage battery 130 connected to a second end of the FDC 120, an inverter 140 of which a DC terminal is connected to the second end of the FDC 120, and a motor 150 connected to an AC terminal of the inverter 140.

The fuel cell 110 may output electric power through a chemical reaction of hydrogen and oxygen. For example, the fuel cell 110 may assume the form of a polymer electrolyte membrane fuel cell (PEMFC: Polymer Electrolyte Membrane Fuel Cell, Proton Exchange Membrane Fuel Cell), and the form is provided for illustrative purposes and the present disclosure is not limited thereto.

The FDC 120 includes two DC terminals, i.e., a first terminal electrically connected to the fuel cell 110 and a second terminal electrically connected to the high voltage battery 130. The FDC 120 may serve to transform a voltage of power input from the first terminal to correspond to a voltage at the second terminal and to output the transformed voltage to the second terminal. To this end, the FDC 120 may include a first capacitor 121 provided to stably maintain the voltage at the first terminal, a second capacitor 122 provided to stably maintain the voltage at the second terminal, and a plurality of pairs of an inductor-leg and a converter controller 123 that are provided to generate boost topology for transformation.

Here, assuming that a normal voltage range of the fuel cell 110 is relatively less than a normal voltage range of the high-voltage battery 130, the first terminal may be referred to as a low-voltage side LS, and the second terminal may be referred to as a high-voltage side HS. The first capacitor 121 may be connected to a negative (−) terminal and a positive (+) terminal of the low-voltage side LS while being located therebetween, and the second capacitor 122 may be connected to a negative (−) terminal and a positive (+) terminal of the high-voltage side HS while being located therebetween. Here, the first capacitor 121 may be referred to as a ‘low-voltage side capacitor’, and the second capacitor 122 may be referred to as a ‘high-voltage side capacitor’.

Furthermore, multiple pairs (N pairs) of inductor-leg may be connected to each other in parallel between the low-voltage side capacitor 121 and the high-voltage side capacitor 122. More specifically, a first terminal of each of N inductors L1, L2, L3, . . . LN may be connected to the positive (+) terminal of the low-voltage side LS, and a second terminal thereof may be connected to a corresponding leg among a plurality of legs Leg1, Leg2, Leg3, . . . LegN, thereby forming a pair of inductor-leg. Hereinafter, each of the inductor-leg pairs may be referred to as a ‘converting circuit’.

Each Leg Leg1, Leg2, Leg3, . . . LegN includes two switching elements connected to each other in series between opposite terminals of the high-voltage side capacitor 122, and a connection node of the two switching elements may be connected to the second terminal of the inductor constituting the pair of inductor-leg. For example, the first leg Leg1 includes a first switching element S11, and a second switching element S12 connected to each other in series between the opposite terminals of the high-voltage side capacitor 122. A connection node of the two switching elements S11 and S12 may be connected to a second terminal of the first inductor L1, thereby forming a first pair of inductor-leg L1-Leg1. The first switching element S11 may be referred to as a ‘top switching element’, and the second switching element S12 may be referred to as a ‘bottom switching element’.

Each of the switching elements may be implemented into a power semiconductor device capable of high-power fast switching, for example, an insulated gate bipolar transistor (IGBT), a metal oxide semiconductor field transistor (MOSFET), or the like, but the present disclosure is not necessarily limited thereto.

Furthermore, based on low-voltage side current IL1, IL2, IL3, . . . ILN, high-voltage side current IH, voltage V_LS between the opposite terminals of the low-voltage side capacitor 121, voltage V_HS between opposite terminals of the high-voltage side capacitor 122, and output current target value, the converter controller 123 may control a state of the switching element constituting each leg Leg1, Leg2, Leg3, . . . LegN through pulse width modulation (PWM). To this end, the FDC 120 may include a current sensor (not shown) and a voltage sensor (not shown) to measure each current and voltage. The output current target value may be information transmitted from a fuel cell control unit (FCU) to be described later.

The high-voltage battery 130 may be connected to the positive (+) terminal and the negative (−) terminal of the high-voltage side HS while being located therebetween via a plurality of switches, for example, a plurality of relays R+, R−, and RP. More specifically, a cathode (−) of the high voltage battery 130 may be selectively connected to the negative (−) terminal of the high-voltage side HS via the negative relay R−, and an anode (+) thereof may be selectively connected to the positive (+) terminal of the high-voltage side HS via a positive relay R+ or the pre-charge relay RP. The pre-charge relay RP may be connected to a pre-charge resistor PCR in series. However, when the negative relay R− and the positive relay R+ are turned on at the same time, a large inrush of current instantaneously occurs for initial charging of the high-voltage side capacitor 122, causing damage to the relays and the capacitors. Therefore, the pre-charge relay RP is turned on first instead of the positive relay R+, and the negative relay R− is turned on, the Inrush current is reduced by the pre-charge resistor PCR connected to the pre-charge relay RP in series, so that the damages to the relays and capacitors can be prevented. When the high-voltage side capacitor 122 is charged above a predetermined voltage, the positive relay R+ is turned on, and the pre-charge relay RP may be turned off. According to implementation, each relay R+, R−, RP may be replaced with different types of switches, for example, with a power semiconductor.

The inverter 140 may convert DC power of the high-voltage battery 130 into multi-phase AC power to drive the motor 150 or may convert AC power generated from the motor 150 into DC power to transmit the DC power to the high-voltage battery 130. Therefore, the inverter 140 may include the plurality of legs respectively corresponding to multi-phases. It should be clear to those having ordinary skill in the art that the multi-phase motor and the inverter to drive the motor can be implemented in various configurations, and the detailed description thereof is described.

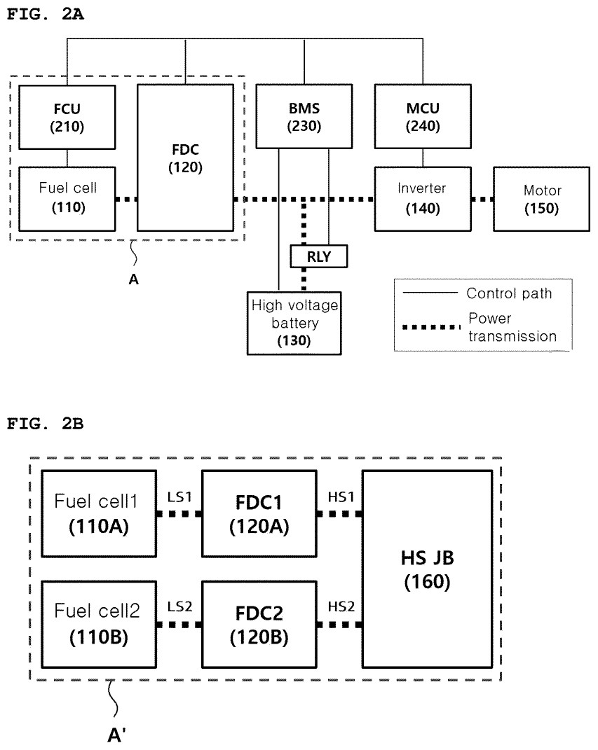

Based on the configuration of a power electronic system described with reference to FIG. 1, a power system and a control system of the fuel cell vehicle are described below with reference to FIGS. 2A and 2B.

FIG. 2A is a view illustrating a control system of a fuel cell vehicle according to an embodiment of the present disclosure. FIG. 2B is a view showing a modified embodiment of part ‘A’ in FIG. 2A.

In FIGS. 2A and 2B, a closed line connecting one element to another element marks a control signal transmission path, and a dotted line marks a power transmission path. Furthermore, in describing FIG. 2A, the power transmission path is equal to the description referring to FIG. 1, and the repeated description thereof is described.

Referring to FIG. 2A, a fuel cell control unit (FCU) 210 controls the fuel cell 110, and the converter controller 123 may perform control of the FDC 120. Furthermore, a battery management system (BMS) 230 may control an on/off state of the relay (RLY: R+, R−, RP), and may manage a state of the high voltage battery 130.

Furthermore, a motor control unit (MCU) 240 may control a gate drive unit (not shown) by a PWM type control signal based on a motor 150 motor angle, phase voltage, phase current, demand torque, and the like, and accordingly, the gate drive unit may control the inverter 140 driving the motor 150.

Each of the control subjects 123, 210, 230, and 240 may exchange information or commands, and the like, necessary for control through communication according to a predetermined vehicle communication protocol, for example, controller area network (CAN) communication.

For each fuel cell vehicle, the plurality of fuel cells that are separately controlled may be provided, and in this case, a DC-DC converter may be provided for each fuel cell. This configuration is described with reference to FIG. 2B. FIG. 2B is a view showing a power transmission path as the center for easy understanding.

In part ‘A’ in FIG. 2A, the singular FDC 120 matches with the singular fuel cell 110. Otherwise, in FIG. 2B, configuration A′ corresponding to part ‘A’ in FIG. 2A includes two fuel cells 110A and 110B, and a first fuel cell 110A is connected to a low-voltage side LS1 of a first FDC (FDC1) 120A, and a second fuel cell 110B is connected to a low-voltage side LS2 of a second FDC (FDC2) 120B. A high-voltage side HS1, HS2 of each FDC 120A, 120B is connected to a first end of a high-voltage side junction box (HS JB) 160. Although not shown in FIG. 2B, a second end of the HSJB 160 may be connected to the high voltage battery 130 and the inverter 140. For example, each high-voltage side HS1, HS2 may be selectively connected to each other in parallel in the HSJB 160. Depending on the implementation, low-voltage side junction boxes (not shown) may be respectively provided between the low-voltage side LS1 of the FDC1 120A and the first fuel cell 110A and the low-voltage side LS2 of the FDC2 120B and the second fuel cell 110B. In this case, a low-voltage side of each FDC is connected to a first end of each of the low-voltage side junction boxes, and a fuel cell corresponding to the corresponding FDC and a fuel cell_balance of plant (FC_BOP, not shown), and the like, which is necessary to drive a stack of the fuel cell, may be connected to a second end of each of the low-voltage side junction boxes.

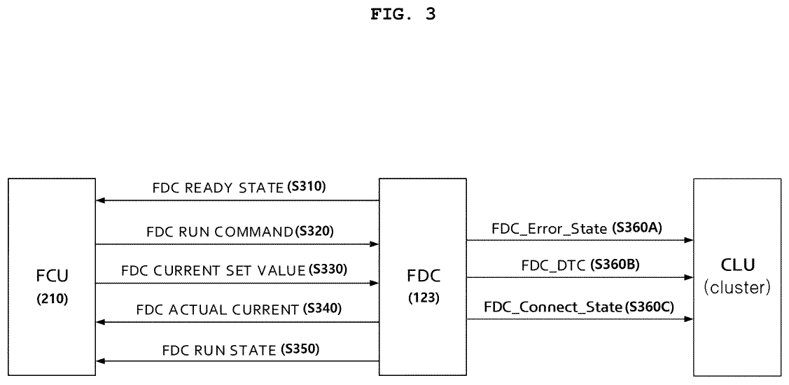

Next, referring to FIG. 3, operation of the converter controller 123 of the FDC 120 through communication with the FCU 210 is described.

FIG. 3 is a view illustrating an exchange signal within a fuel cell controller, a DC-DC converter, and a cluster according to an embodiment of the present disclosure.

Referring to FIG. 3, the converter controller 123 transmits a message, which includes a ready state (ready on/off) of the FDC 120, or a signal (FDC ready state) to the FCU 210, at S310. When the FDC 120 is in a ready on state, the FCU 210 transmits an operation start command message (FDC run command), at S320. Here, an output current set value (FDC current set value) may be also transmitted, at S330. Accordingly, the converter controller 123 drives the FDC 120 to satisfy the FDC current set value, and as a result, a current value (FDC actual current) actually output from the FDC 120 is transmitted to the FCU 210, at S340. Furthermore, the converter controller 123 may transmit a message (FDC run state) including a ready state (run on/off) of the FDC 120 to the FCU 210, at S350.

The converter controller 123 may transmit the information about the run state of the FDC 120 or an error detected when an error is detected during running to the output device capable of informing the user of the information, at S360A, S360B, and S360C. In FIG. 3, the output device is assumed to be a cluster CLU, but the cluster is provided for illustrative purposes, and the present disclosure is not necessarily limited thereto. For example, the output device may be a terminal of AVNT (audio/video/navigation) system.

Specifically, the converter controller 123 may transmit an error state through an FDC_error_state signal, at S360A, and may transmit failure information through a FDC_DTC signal, at S360B. Furthermore, the converter controller 123 may transmit information about a connector coupling state such as normal coupling, non-coupling, miscoupling, and the like, through an FDC_connect_state signal, at S360C. The cluster may output a corresponding visual effect, such as a warning message, icon, lighting up of a warning light, and the like, based on the signal transmitted from the converter controller 123 and the preset information output condition.

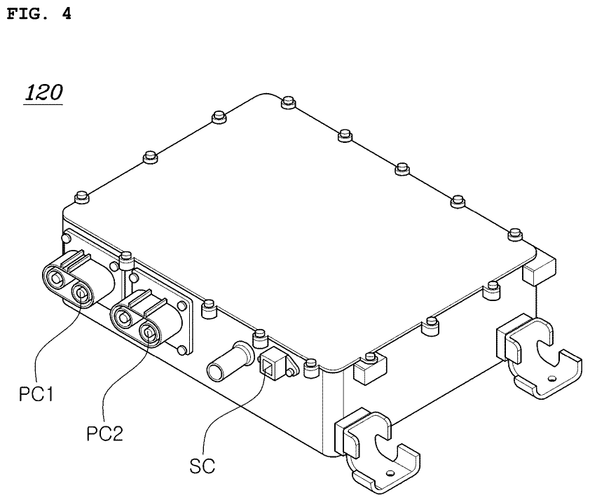

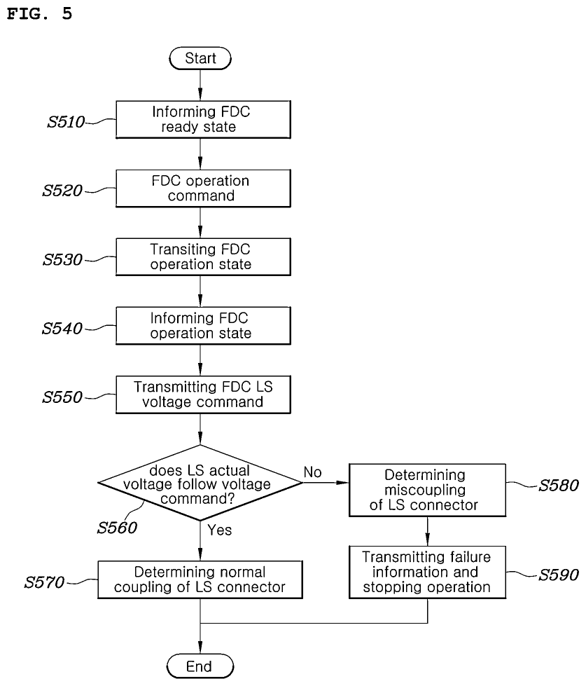

The occurrence of non-coupling may be determined based on an interlocking method (a method in which a conductor is provided at a connector so that two pins provided in an inlet are short-circuited to each other when the connector is coupled) that is widely applied to detect whether or not a connector of an electrified vehicle is coupled. Determining whether or not miscoupling occurs is described below with reference to FIGS. 4 and 5.

FIG. 4 is a perspective view showing the exterior shape of the DC-DC converter according to an embodiment.

Referring to FIG. 4, the FDC 120 may include two power connector inlets PC1 and PC2, and a control signal connector inlet SC. Any one of the two power connector inlets PC1 and PC2 corresponds to the low-voltage side LS and another one thereof may correspond to the high-voltage side HS. When the FDC 120 is applied to the system as shown in FIG. 2B, the two different FDCs 120A and 120B may be mounted in the vehicle while being adjacent to each other. For example, when the two different FDCs 120A and 120B are stacked vertically, there is a risk that a connector connected to the first fuel cell 110A is miscoupled to the low-voltage side LS1 of the FDC1 120A and a connector connected to the second fuel cell 110B is miscoupled to the low-voltage side LS2 of the FDC2 120B due to operator error during vehicle production or maintenance. Whether or not the miscoupling situation occurs and the countermeasures therefor are described with reference to FIG. 5.

FIG. 5 is a flowchart illustrating a control process of a vehicle according to an embodiment of the present disclosure. In FIG. 5, it is assumed that each control signal cable is normally mounted based on the system in FIG. 2B and communication between a FCU1 (not shown) corresponding to the first fuel cell 110A and the FDC1 120A is not normally performed.

Referring TO FIG. 5, as the FDC1 120A finishes preparing for operation, the FDC1 120A may inform the FCU1 of a ready notification through the FDC ready on signal, at S510.

Accordingly, the FCU1 may command operation through the FDC run command signal to the FDC1 120A, at S520.

According to the run command, the FDC1 120A may transition an operation state in the order of standby-pre-active-active, at S530. Each operation state is as follows.

In an embodiment, the operation state of the FDC 120 may include an initial check state, a standby state, a pre-active state, and an active state. For example, the initial check state may correspond to a state where the converter controller 123 performs an initialization operation with respect to a current sensor and a voltage sensor of the FDC 120. At the above-described S530, it is described to assume that the state has already been performed. The standby state may correspond to a state where after the initialization operation is completed, a powering operation with respect to the FDC 120 is ready. The pre-active state may correspond to a state where before the converter controller 123 performs the powering operation with respect to the FDC 120, the converter controller 123 checks whether or not values sensed from the current sensor and the voltage sensor of the FDC 120 are included within the preset range. The active state may correspond to a state where after the converter controller 123 completes the checking operation in the pre-active state, the converter controller 123 performs the powering operation with respect to the FDC 120. In other words, the active state may correspond to a state where the converter controller 123 switches the switching elements included in the FDC 120.

However, the classification and transition order of each operation state described above are provided for illustrative purposes, and the present disclosure is not necessarily limited thereto.

When the FDC1 120A is in the active state, the FDC1 may inform the FCU1 of an operation state where power converting starts (converting start) through an FDC_controllable signal, at S540.

The FCU1 may transmit a voltage command signal (LS Ref voltage) with respect to the low-voltage side LS1 of the FDC1 120A, at S550.

The FDC1 120A may compare a voltage experimental value (i.e., LS actual voltage) sensed by the voltage sensor of the low-voltage side LS1 to a voltage command transmitted from the FCU1, and determine whether or not the LS actual voltage follows the voltage command, at S560. Here, the fact that the LS actual voltage follows the voltage command means that the LS actual voltage and the voltage command have a difference within a predetermined voltage range within a preset time.

However, when the LS actual voltage follows the voltage command, the FDC 1 120A determines that coupling of a low-voltage side connector is normally performed, at S570.

Otherwise, when the LS actual voltage does not follow the voltage command, the FDC1 120A may determine that the low-voltage side connector is miscoupled, at S580. For example, when the connector of the second fuel cell 110B side or the connector corresponding to the high-voltage side is coupled to the low-voltage side inlet of the FDC1 120A, the LS actual voltage does not follow the voltage command, and the fact means miscoupling of the connector.

When miscoupling of the connector is determined, the FDC1 120A may transmit error information (e.g., S360A, S360B, S360C, and the like in FIG. 3) to the output device such as the cluster, and the like, and may abort operation, such as performing shutdown. Accordingly, the output device may output warning information of a predetermined form. For example, the output of warning information may include: displaying visual information through the cluster; notification of a smart device through telematics communication; output of a warning sound via a speaker, which is provided for illustrative purposes, and the present disclosure is not necessarily limited thereto.

FIG. 5 has been described based on the operation of the FDC1 120A and the operation of the FCU1, but in the vehicle in which the plurality of FDCs correspond to different fuel cell controllers FDC, each FDC may individually determine whether or not a connector is miscoupled to one side inlet thereof. For example, in the system as shown in FIG. 2B, the FDC2 120B may also determine whether or not miscoupling of a connector connected to an inlet thereof occurs, apart from the determination of miscoupling of the FDC1 120A.

According to the above-described embodiment of the present disclosure, the DC-DC converter can efficiently detect and correspond to connector miscoupling. Specifically, the DC-DC converter determines whether or not miscoupling occurs based on whether or not the actual voltage follows the voltage command with respect to one side, and when the miscoupling is determined, operation is stopped (operation S590), thereby protecting the DC-DC converter and the devices connected thereto.

The above-described present disclosure can be implemented as computer-readable code on a medium on which a program is recorded. The computer-readable medium includes all types of recording devices in which data that can be read by a computer system is stored. As an example of the computer-readable medium, a HDD (Hard Disk Drive), SSD (Solid State Disk), SDD (Silicon Disk Drive), read-only memory (ROM), random-access memory (RAM), compact-disk ROM (CD-ROM), magnetic tape, floppy disk, optical data storage device, and the like, may be proposed. Accordingly, the above-detailed description should not be construed as limiting in all respects and should be considered illustrative. The scope of the present disclosure should be determined by reasonable interpretation of the accompanying claims and all changes within the equivalent scope of the present disclosure are included in the scope of the present disclosure.

What is claimed is:

1. A direct current to direct current (DC-DC) converter comprising:
a first inlet corresponding to a first DC terminal;
a transformation circuit connected to the first direct current (DC) terminal and a second DC terminal while being located therebetween; and
a converter controller, wherein when receiving a voltage command corresponding to the first DC terminal from an external controller, the converter controller is configured to determine whether a connector coupled to the first inlet is miscoupled thereto based on whether or not a voltage of the first DC terminal follows the voltage command.

2. The DC-DC converter of claim 1, wherein the external controller comprises a fuel cell control unit (FCU) configured to control a fuel cell.

3. The DC-DC converter of claim 1, wherein when the voltage of the first DC terminal follows the voltage command, the converter controller is further configured to determine that coupling of the connector is normally performed.

4. The DC-DC converter of claim 1, wherein when the voltage of the first DC terminal does not follow the voltage command, the converter controller is further configured to determine that miscoupling of the connector occurs.

5. The DC-DC converter of claim 1, wherein when the voltage of the first DC terminal does not follow the voltage command, the converter controller is further configured to transmit an error signal.

6. The DC-DC converter of claim 1, wherein when the voltage of the first DC terminal does not follow the voltage command, the converter controller is further configured to perform shutdown operation.

7. The DC-DC converter of claim 1, wherein the voltage command is transmitted after informing the external controller of an operation state in which power converting starts.

8. The DC-DC converter of claim 1, further comprising:
a second inlet corresponding to the second DC terminal.

9. The DC-DC converter of claim 1, wherein the transformation circuit comprises:
an inductor of which a first terminal is connected to a positive (+) terminal of the first DC terminal; and
a leg of which a first terminal is connected to a positive (+) terminal of the second DC terminal and a second terminal is connected to a negative (−) terminal of the second DC terminal,
wherein the leg comprises two switching elements connected to each other in series, and
a second terminal of the inductor is connected to a connection node of the two switching elements.

10. A vehicle comprising:
a first power source;
a first controller configured to control the first power source; and
a direct current to direct current (DC-DC) converter comprising a first inlet corresponding to a first direct current (DC) terminal, wherein when receiving a voltage command corresponding to the first DC terminal from the first controller, the DC-DC converter determines whether or not a connector coupled to the first inlet is miscoupled thereto based on whether or not a voltage of the first DC terminal follows the voltage command.

11. The vehicle of claim 10, wherein the first power source comprises a fuel cell, and
the first controller comprises a fuel cell control unit (FCU) configured to control the fuel cell.

12. The vehicle of claim 10, wherein when the voltage of the first DC terminal follows the voltage command, the DC-DC converter is further configured to determine that coupling of the connector is normally performed.

13. The vehicle of claim 10, wherein when the voltage of the first DC terminal does not follow the voltage command, the DC-DC converter is further configured to determine that miscoupling of the connector occurs.

14. The vehicle of claim 10, further comprising:
an output device configured to transmit visual or audible warning information,
wherein when a voltage of the first DC terminal does not follow the voltage command, the DC-DC converter is further configured to transmit an error signal to the output device.

15. The vehicle of claim 10, further comprising:
a second power source and a second controller configured to control the second power source,
wherein the DC-DC converter comprises a second inlet corresponding to a second DC terminal.

16. A vehicle comprising:
a plurality of DC-DC converters;
a plurality of fuel cells each corresponding to one DC terminal of different one DC-DC converter among the plurality of DC-DC converters; and
a plurality of fuel cell controllers each configured to control a different, one fuel cell among the plurality of fuel cells,
wherein when transmitting a voltage command corresponding to the one DC terminal from a corresponding fuel cell controller among the plurality of fuel cell controllers, each of the plurality of DC-DC converters is configured to determine whether miscoupling of a connector coupled to an inlet corresponding to the one DC terminal occurs based on whether or not a voltage of the one DC terminal follows the voltage command.
